(19) United States
(12) Patent Application Publication
(10) Pub. No.: US 2006/0268673 A1
(43) Pub. Date: Nov. 30, 2006

(54) Method, apparatus, and system for transmitting and receiving data in a digital broadcasting system using a single frequency network

(75) Inventors: Hee-Jin Roh, Suwon-si (KR); Kyung-Ha Lee, Seoul (KR); Suk-Jin Jung, Yongin-si (KR); Min-Goo Kim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/406,602

(22) Filed: Apr. 19, 2006

(30) Foreign Application Priority Data
Apr. 19, 2005 (KR) 2005-0032528

(51) Int. Cl. H04J 11/00

(52) U.S. Cl. 370/203

(57) ABSTRACT

A method, apparatus, and system for transmitting and receiving data in a digital broadcasting system based on Orthogonal Frequency Division Multiplexing (OFDM) are provided. A transmitter frames input bit information in a predetermined bit unit, maps the framed input bit information to a transmitter identification indicator (TII) using a predefined number of orthogonal sets, and modulates the TII to an OFDM symbol to transmit the OFDM symbol. A receiver demodulates an OFDM symbol, detects a TII symbol from a predefined orthogonal signal set, demaps predetermined bits from the TII, and concatenates the demapped bits in a predetermined period unit to output bit information. Therefore, the TII can be stably received as a conditional access signal for distinguishing a broadcasting network and a relay network in the digital broadcasting system.

### PRIORITY

This application claims the benefit under 35 U.S.C. §119(a) of Korean Patent Application Serial No. 2005-32528, filed Apr. 19, 2005 in the Korean Intellectual Property Office, the entire contents of which are hereby incorporated by reference.

### BACKGROUND OF THE INVENTION

1. Field of the Invention

The present invention generally relates to a method, apparatus, and system for transmitting and receiving data in an Orthogonal Frequency Division Multiplexing (OFDM) system. More particularly, the present invention relates to a method, apparatus, and system for transmitting and receiving data in a digital broadcasting system based on OFDM.

2. Description of the Related Art

A typical wireless communication system for applying a multicarrier modulation scheme is an Orthogonal Frequency Division Multiplexing (OFDM) system in which multiple orthogonal subcarriers overlap. The OFDM system converts a serially input symbol stream in parallel and then modulates and transmits parallel symbols through a plurality of orthogonal subcarriers. The OFDM is robust to a frequency-selective multipath-fading channel as compared with a conventional single-carrier modulation scheme.

Because there is a frequency selective channel in a frequency band occupied by a plurality of subcarriers and a frequency nonselective channel in each subcarrier band in view of a receiver side, a channel can be easily compensated through a simple channel equalization process. Specifically, the OFDM system copies a second half part of each OFDM symbol, attaches the copied part as a Cyclic Prefix (CP) before the OFDM symbol, and transmits the OFDM symbol, thereby removing InterSymbol Interference (ISI) from a previous symbol. Because the above-described OFDM system is robust to a multipath fading channel, its transmission scheme is suitable for broadband digital transmission technologies of a Digital Audio Broadcasting (DAB) system, a Wireless Local Area Network (WLAN), and so on.

A digital broadcasting system recently receiving attention is a Digital Multimedia Broadcasting (DMB) system covering all audio, video, and data services. The DMB system is divided into terrestrial DMB for receiving a broadcasting service through a terrestrial relay on the ground and satellite DMB using an artificial satellite as a relay. Also research is being conducted on a system in which the terrestrial DMB and the satellite DMB are mixed. The DMB system can provide a digital broadcasting service for various multimedia signals of voice and video to fixed, portable, and vehicle receivers. The use of the DMB system will significantly increase in the future because the DMB system can provide high audio and image quality broadcasting based on the levels of a Compact Disc (CD) and Digital Video Disc (DVD) through a Personal Digital Assistant (PDA) or vehicle terminal on the move.

Hereinafter, the digital broadcasting system is interpreted as meaning the DAB and DMB systems. On the other hand, a typical example of the OFDM-based DAB system is a European Research Coordination Agency (Eureka) project-147 system. Specifically, the Eureka project-147 system has been recently applied to a terrestrial DMB system for service according to a need of the convergence of digital broadcasting and communication and mobile broadcasting. The Eureka project-147 system configures a Single Frequency Network (SFN) using a plurality of broadcasting transmitters.

The use of the SFN in the OFDM system means that multiple transmitters send an identical data signal at an identical frequency. Because signals sent from the transmitters are synchronized with transmission timing, they do not act as an interference component to each other and exhibit the effect as in a multipath channel, such that the quality of received signals is improved in the receiver. For this reason, the OFDM system using the SFN can be applied to the digital broadcasting system. This digital broadcasting system configures a network in which all transmitters send identical broadcasting data at an identical frequency, and can be easily implemented using a concept of an identical frequency network under condition that multiple users must receive data.

However, a broadcasting service recently being discussed requires a function for selectively providing various contents rather than only identical broadcasting according to service requirements and qualifications of users. This function is enabled by exploiting a conditional access system. The conditional access system is defined as a control system for limiting access according to access conditions when data is transmitted from a transmitter to multiple terminals. The conditional access system can perform a control operation such that a part or total of a transmitted broadcasting or data service can be selectively received according to access authorization of a terminal.

Broadcasting service providers can implement, for example, a differential billing system by controlling service reception conditions of each terminal using the conditional access system. In relation to this, the terrestrial DMB system is advantageous in that it can provide free information to more viewers as in the conventional terrestrial TV broadcasting. Service conditions associated with billing and so on according to the introduction of a special conditional access system can be discussed when an additional relay is required as in a shadow region and so on.

To implement the above-described conditional access system, a broadcasting network operable for a broadcasting transmitter located in a non-shadow region needs to be distinguished from a relay network operable for a broadcasting transmitter located in a shadow region like a relay. When the broadcasting network is distinguished from the relay network, a terminal must be able to determine whether to receive a broadcasting or data service from the broadcasting network or the relay network. A system for distinguishing a network is seriously needed. That is, a need exists for an improved method for transmitting and receiving data that can distinguish the broadcasting network and the relay network while improving reception quality of data using the SFN in the digital broadcasting system.

### SUMMARY OF THE INVENTION

It is an object of the present invention to provide a method, apparatus, and system for transmitting and receiving data that can distinguish a broadcasting network and a relay network while using a single frequency network in a digital broadcasting system.

It is another object of the present invention to provide a method, apparatus, and system for transmitting and receiving data that can distinguish a broadcasting network and a relay network and operate a conditional access system in a digital broadcasting system.

It is another object of the present invention to provide a method, apparatus, and system for transmitting and receiving a conditional access signal for setting conditional access in a digital broadcasting system.

It is yet another object of the present invention to provide a method, apparatus, and system for transmitting and receiving data that can use a transmitter identification indicator as a conditional access signal and improve reception quality in a digital broadcasting system.

In accordance with an aspect of the present invention, there is provided a method for transmitting a transmitter identification indicator (TII) in a digital broadcasting system, comprising the steps of: framing input bit information in a predetermined bit unit; mapping the framed input bit information to the TII using a predefined orthogonal set; and modulating the TII to an Orthogonal Frequency Division Multiplexing (OFDM) symbol and transmitting the OFDM symbol.

In accordance with another aspect of the present invention, there is provided a transmission apparatus for transmitting a transmitter identification indicator (TII) in a digital broadcasting system, comprising: a frame divider for framing input bit information in a predetermined bit unit; an orthogonal signal point mapper for mapping the framed input bit information to the TII using a predefined orthogonal set; and a modulator for modulating the TII to an Orthogonal Frequency Division Multiplexing (OFDM) symbol and transmitting the OFDM symbol.

In accordance with another aspect of the present invention, there is provided a reception method for use in a digital broadcasting system for transmitting a Transmitter Identification Indicator (TII), comprising the steps of: detecting a TII symbol from a predefined orthogonal signal set after demodulating an Orthogonal Frequency Division Multiplexing (OFDM) symbol; demapping predetermined bits from the TII symbol; and concatenating the demapped bits in a predetermined period unit and outputting bit information.

In accordance with another aspect of the present invention, there is provided a reception apparatus for use in a digital broadcasting system for transmitting a Transmitter Identification Indicator (TII), comprising: an Orthogonal Frequency Division Multiplexing (OFDM) demodulator for demodulating a received OFDM symbol; an orthogonal symbol detector for detecting a TII symbol from a predefined orthogonal signal set within the demodulated OFDM symbol; a symbol-to-bit demapper for demapping predetermined bits from the TII symbol; and a bit combiner for concatenating the demapped bits in a predetermined period unit and outputting bit information.

In accordance with yet another aspect of the present invention, there is provided a digital broadcasting system for transmitting a transmitter identification indicator (TII), comprising: a transmitter for framing input bit information in a predetermined bit unit, mapping the framed input bit information to the TII using a predefined orthogonal set, modulating the TII to an Orthogonal Frequency Division Multiplexing (OFDM) symbol, and transmitting the OFDM symbol; and a receiver for demodulating a received OFDM symbol, detecting a TII symbol from a predefined orthogonal signal set within the. demodulated OFDM symbol, demapping predetermined bits from the TII symbol, concatenating the demapped bits in a predetermined period unit, and outputting bit information.

### BRIEF DESCRIPTION OF THE DRAWINGS

The above and other objects and aspects of the present invention will be more clearly understood from the following detailed description taken in conjunction with the accompanying drawings, in which:

FIG. 1 illustrates a structure of a physical layer frame of a conventional Digital Audio Broadcasting (DAB) system;

FIG. 2 is a block diagram illustrating a transceiver of the conventional DAB system for transmitting and receiving a Transmitter Identification Indicator (TII);

FIG. 3 is a block diagram illustrating a structure of a digital broadcasting system to which the present invention is applied;

FIG. 4 is a block diagram illustrating a structure of a transmitter in the digital broadcasting system in accordance with an exemplary embodiment of the present invention;

FIG. 5 illustrates an example of orthogonal signal mapping in accordance with an exemplary embodiment of the present invention;

FIG. 6 illustrates a structure of a frame in accordance with an exemplary embodiment of the present invention;

FIG. 7 is a flowchart illustrating a method for transmitting data in the digital broadcasting system in accordance with an exemplary embodiment of the present invention;

FIG. 8 is a block diagram illustrating a structure of a receiver in the digital broadcasting system in accordance with an exemplary embodiment of the present invention; and

FIG. 9 is a flowchart illustrating a method for receiving data in the digital broadcasting system in accordance with an exemplary embodiment of -the present invention.

Throughout the drawings, the same drawing reference numerals will be understood to refer to the same elements, features and structures.

### DETAILED DESCRIPTION OF THE EXEMPLARY EMBODIMENTS

Exemplary embodiments of the present invention will be described in detail herein below with reference to the accompanying drawings. In the following description, detailed descriptions of functions and configurations incorporated herein that are well known to those skilled in the art are omitted for clarity and conciseness.

First, a digital broadcasting system to which the present invention is applied will be described with reference to an example of a terrestrial Digital Multimedia Broadcasting (DMB) system. It is assumed that the terrestrial DMB system exploits a European Research Coordination Agency (Eureka) project-147 system serving as a Digital Audio Broadcasting (DAB) system.

For a better understanding of the present invention, a physical layer structure of a conventional DAB system and a structure of a transceiver for transmitting and receiving a Transmitter Identification Indicator (TII) will be briefly described.

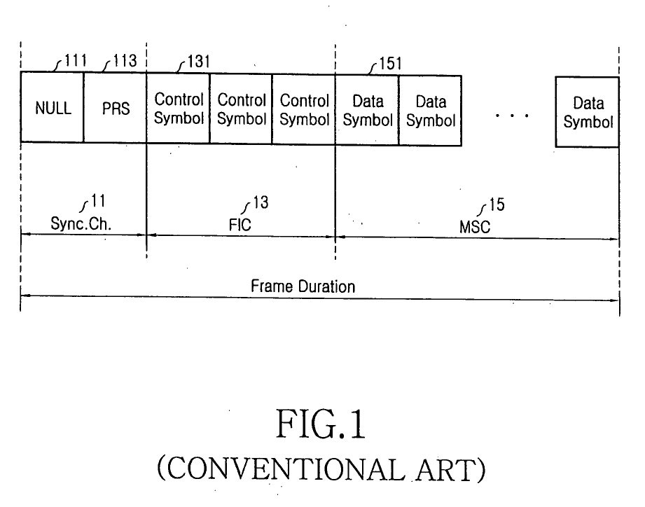

FIG. 1 illustrates a structure of a physical layer frame of a conventional DAB system.

A transmission frame of FIG. 1 is constructed by a synchronization channel 11, a Fast Information Channel (FIC) 13, and a Main Service Channel (MSC) 15. In the synchronization channel 11, a NULL symbol 111 corresponding to the first symbol is used for synchronization of a physical layer, and a Phase Reference Symbol (PRS) 113 corresponding to the second symbol provides a phase reference for differential modulation on the next OFDM symbol. The FIC 13 transmits control symbols 131 and the MSC 15 transmits data symbols 151. The NULL symbol 111 can transmit a TII, and is transmitted through a plurality of subcarriers. The TII can be sent through a transmitter of a broadcasting station or through a broadcasting transmitter of a broadcasting network.

The TII is constructed by 12 bits including 7 bits of a main Identifier (ID) and 5 bits of a sub ID. The TII is inserted into a position of the NULL symbol 11, and is transmitted through the synchronization channel 11 according to an Orthogonal Frequency Division Multiplexing (OFDM) scheme. The TII is expressed as shown in Equation (1), and conventionally provides identification information about each transmitter in a DAB network using a Single Frequency Network (SFN).

$$\begin{matrix}{s}_{TII} ( t ) = Re \{ {ⅇ}^{2 j π {f}_{c} t} {\sum }_{m = - ∞}^{+ ∞} {\sum }_{k = - K / 2}^{K / 2} {Z}_{m , 0 , k} \cdot {g}_{TII , k} ( t - m {T}_{F} ) \} \\ {g}_{TII , k} ( t ) = {ⅇ}^{2 π f k ( t - {T}_{NULL} + {T}_{U} ) / {T}_{U}} \cdot Rect ( t / {T}_{NULL} )\end{matrix} \qquad Equation ( 1 )$$

In Equation (1), f_{c} is a Radio Frequency (RF) subcarrier frequency, Z_{m,o,k} is a TII signal to be transmitted through a k-th subcarrier in a NULL symbol position of an m-th frame, g_{TII,k} (t) denotes a modulation signal of k-th subcarrier in a TII symbol position, and g_{TII,k} (T−mT_{F}) denotes a modulation signal of k-th subcarrier in a TII symbol of an m-th frame.

The TII uses a structure in which a k-th PRS value of e^{jφk} is repeatedly transmitted through k-th and k+1-th subcarriers as shown in Equation (2).
Z_{m,0,k}=A_{c,p}(k)·e^{jφ}^{ₖ}+A_{c,p}(k+1)·e^{jφ}^{ₖ₊₁} Equation (2)

In Equation (2), A_{c,p} sets a subcarrier through which a TII signal is actually transmitted on the basis of an index p indicating a main ID and an index c indicating a sub ID, and is defined as shown in Equation (3).

$$\begin{matrix}{A}_{c , p} ( k ) = \\ \{ \begin{matrix}{\sum }_{b = 0}^{ 7} δ ( k , - 768 + 2 c + 48 b ) \cdot {a}_{b} ( p ) & for - 768 \leq k < - 384 \\ {\sum }_{b = 0}^{ 7} δ ( k , - 384 + 2 c + 48 b ) \cdot {a}_{b} ( p ) & for - 384 \leq k < 0 \\ {\sum }_{b = 0}^{ 7} δ ( k , 1 + 2 c + 48 b ) \cdot {a}_{b} ( p ) & for 0 < k \leq 384 \\ {\sum }_{b = 0}^{ 7} δ ( k , 385 + 2 c + 48 b ) \cdot {a}_{b} ( p ) & for 384 < k \leq 768\end{matrix}\end{matrix} \qquad Equation ( 3 )$$

a_{b} (p) of Equation (3) is a transmission pattern of a TII set by a main ID index p, and is defined as shown in Table 1.

TABLE 1

| | a_{b}(p) |
|---|---|
| p | b = 0, 1, 2, 3, 4, 5, 6, 7 |
| 0 | 00001111 |
| 1 | 00010111 |
| 2 | 00011011 |
| 3 | 00011101 |
| 4 | 00011110 |
| 5 | 00100111 |
| 6 | 00101011 |
| 7 | 00101101 |
| 8 | 00101110 |
| 9 | 00110011 |
| 10 | 00110101 |
| 11 | 00110110 |
| 12 | 00111001 |
| 13 | 00111010 |
| 14 | 00111100 |
| 15 | 01000111 |
| 16 | 01001011 |
| 17 | 01001101 |
| 18 | 01001110 |
| 19 | 01010011 |
| 20 | 01010101 |
| 21 | 01010110 |
| 22 | 01011001 |
| 23 | 01011010 |
| 24 | 01011100 |
| 25 | 01100011 |
| 26 | 01100101 |
| 27 | 01100110 |
| 28 | 01101001 |
| 29 | 01101010 |
| 30 | 01101100 |
| 31 | 01110001 |
| 32 | 01110010 |
| 33 | 01110100 |
| 34 | 01111000 |
| 35 | 10000111 |
| 36 | 10001011 |
| 37 | 10001101 |
| 38 | 10001110 |
| 39 | 10010011 |
| 40 | 10010101 |
| 41 | 10010110 |
| 42 | 10011001 |
| 43 | 10011010 |
| 44 | 10011100 |
| 45 | 10100011 |
| 46 | 10100101 |
| 47 | 10100110 |
| 48 | 10101001 |
| 49 | 10101010 |
| 50 | 10101100 |
| 51 | 10110001 |
| 52 | 10110010 |
| 53 | 10110100 |
| 54 | 10111000 |
| 55 | 11000011 |
| 56 | 11000101 |
| 57 | 11000110 |
| 58 | 11001001 |
| 59 | 11001010 |
| 60 | 11001100 |
| 61 | 11010001 |
| 62 | 11010010 |
| 63 | 11010100 |
| 64 | 11011000 |
| 65 | 11100001 |
| 66 | 11100010 |
| 67 | 11100100 |
| 68 | 11101000 |
| 69 | 11110000 |

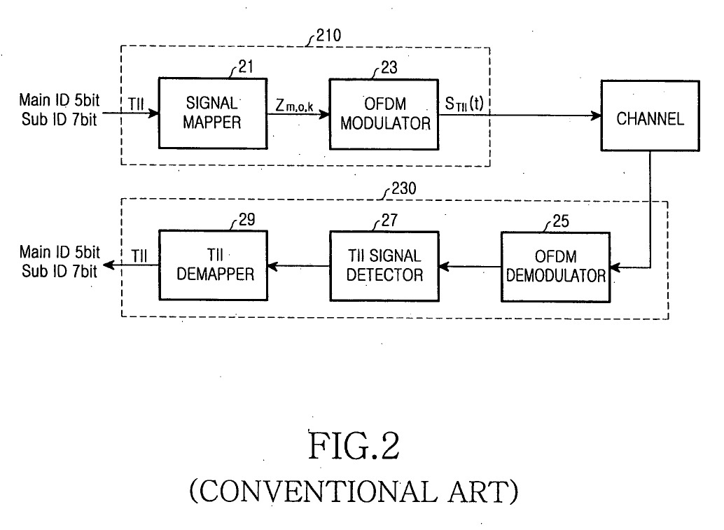

FIG. 2 is a block diagram illustrating a transceiver of the conventional DAB system for transmitting and receiving a TII.

Referring to a structure of a transmitter 210 in FIG. 2, a signal mapper 21 performs a mapping process such that a 7-bit main ID and a 5-bit sub ID are transmitted through a k-th subcarrier in a NULL symbol position of an m-th frame. An OFDM modulator 23 modulates a mapped TII signal Z_{m,0,k}, generates an OFDM symbol as shown in Equation (1), and transmits the OFDM symbol to a wireless network through a radio channel. Referring to a structure of a receiver 230 in FIG. 2, an OFDM demodulator 25 demodulates the TII signal received through the radio channel, and a TII signal detector 27 detects the TII signal transferred in the NULL symbol position. Subsequently, a TII demapper 29 demaps the TII signal transmitted through the k -th subcarrier in the NULL symbol position of the m-th frame, and outputs the TII constructed by the 7-bit main ID and the 5-bit sub ID. As a result, the receiver 230 receives the TII signal through the above-described structure, thereby identifing the transmitter 210 for transmitting data.

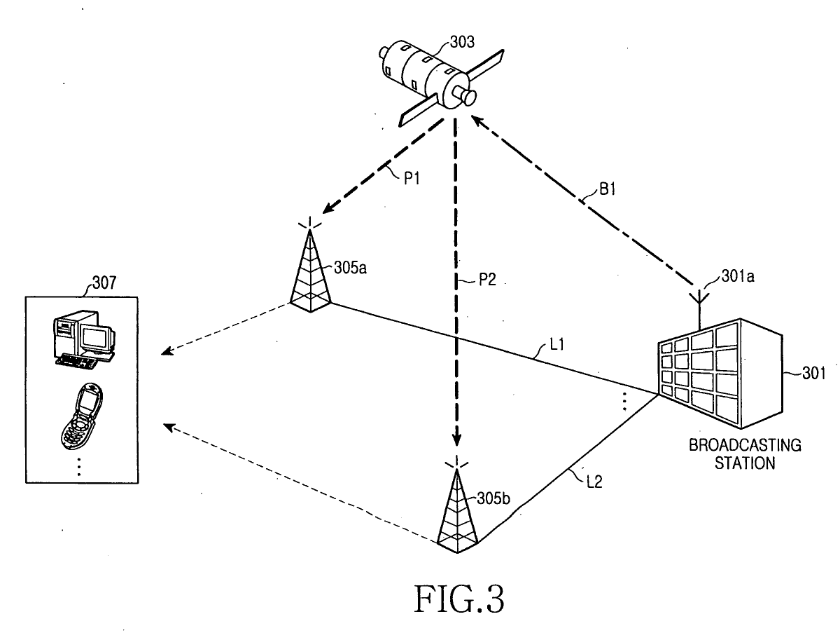

In relation to the TII, the present invention uses the TII as a signal for setting conditional access of a broadcasting network and a relay network in an example of a service distinguished between the broadcasting network and the relay network. For this, the present invention proposes a method for improving reception quality of the TII. Next, a structure of the digital broadcasting system to which the present invention is applied will be described with reference to FIG. 3.

In this exemplary embodiment, the broadcasting network indicates a network for transmitting broadcasting data transferred from a broadcasting station 301 to a service area through a broadcasting transmitter 305a (hereinafter, referred to as a first broadcasting transmitter) located in a non-shadow region. The relay network indicates a network for transmitting broadcasting data transferred from the broadcasting station 301 to a service area through a broadcasting transmitter 305b (hereinafter, referred to as a second broadcasting transmitter) located in a shadow region such as a region where buildings are dense, subway, and so on. The broadcasting network and the relay network configure the SFN. The first and second broadcasting transmitters 305a and 305b transmit, to an associated service area, identical broadcasting data at an identical frequency. A terminal 307 with a broadcasting receiver such as a mobile phone, a Personal Digital Assistant (PDA), a notebook computer, and so on receives broadcasting data transmitted through the first broadcasting transmitter 305a or the second broadcasting transmitter 305b.

Broadcasting data transmitted through a satellite antenna 301a of the broadcasting station 301 can be transferred to the first broadcasting transmitter 305a or/and the second broadcasting transmitter 305b through a broadcasting satellite 303 (as indicated by B1, P1, and P2). The broadcasting station 301 is connected to the first broadcasting transmitter 305a and the second broadcasting transmitter 305b through wires L1 and L2, such that the broadcasting data can be transferred. Herein, the first broadcasting transmitter 305a can selectively use a gap filler of an individual provider or a special broadcasting transmission tower managed in a country or a broadcasting station. In an exemplary embodiment, the second broadcasting transmitter 305b uses the gap filler capable of covering the shadow region. For convenience, one first broadcasting transmitter 305a and one second broadcasting transmitter 305b are illustrated in FIG. 3, respectively. However, a plurality of first or second broadcasting transmitters 305a or 305b can be actually present. In an exemplary embodiment, the second broadcasting transmitter 305b is installed in every shadow region such that a service can be smoothly provided.

An exemplary embodiment of the present invention uses a TII to identify the broadcasting network and the relay network in the digital broadcasting system as shown in FIG. 3. When 12 bits of the TII with a pattern as shown in Table 1 are transmitted without modification, there is a problem in that reception performance of the TII is more degraded than data demodulation performance in a mobile channel environment. That is, the TII is transmitted through a plurality of subcarriers scattered at frequencies, and frequency diversity can be obtained because a terminal serving as a receiver combines received information and detects 12 bits of a TII code. However, because a low intensity signal is received if the NULL symbol suffers from fading in a mobile channel environment, TII detection performance can be severely degraded. This degradation becomes more severe as the region is closer to an-overlap region between networks.

In the conventional digital broadcasting system, the coverage in which the receiver can receive broadcasting data is relatively wide, whereas the coverage in which the receiver can receive a TII is relatively narrow. When the digital broadcasting system interworks with a conditional access system, the reception coverage of the broadcasting data is limited to that of the TII. Thus, the present invention proposes a new TII transmission scheme for maintaining the compatibility in a physical layer with the conventional DAB system that transmits the 12-bit TII without modification and improving TII detection performance. Because broadcasting transmitters of the SFN must transmit identical data, the transmission scheme must be separately defined to transmit a signal while distinguishing a broadcasting transmitter between the broadcasting network and the relay network.

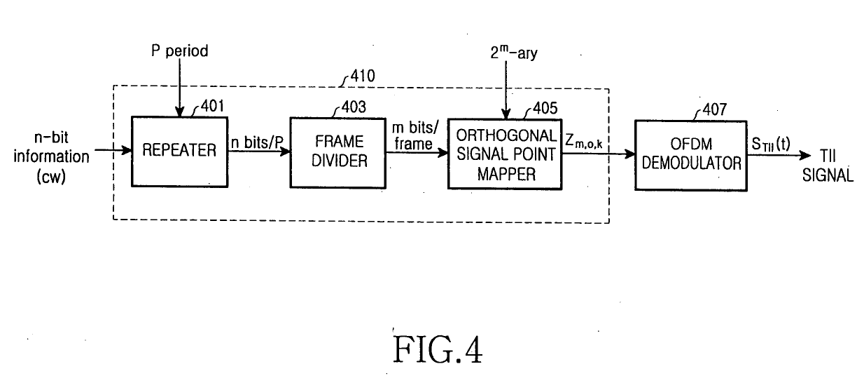

FIG. 4 is a block diagram illustrating a structure of a transmitter in the digital broadcasting system in accordance with an exemplary embodiment of the present invention. A scheme for sending transmitter-by-transmitter signals in a physical layer will be described with reference to FIGS. 4 to 6.

In FIG. 4, the transmitter is provided with a signal mapper 410 for setting a modulation set for transmitting a TII to an orthogonal set and an OFDM modulator 407 for modulating a mapped TII to an OFDM symbol and transmitting the OFDM symbol in accordance with an exemplary embodiment of the present invention. Within the signal mapper 410, a symbol or sequence repeater 401 repeats and outputs n-bit information to be transmitted during a defined period. A frame divider 403 divides the n-bit information into frames in a predefined m-bit unit. An orthogonal signal point mapper 405 maps a predetermined orthogonal set to a NULL symbol position of a frame such that orthogonal modulation of the divided bit information and transmitter-by-transmitter data transmission are performed.

When a free service is provided through the broadcasting network and a pay service is provided through the relay network, a Control Word (CW) for descrambling broadcasting data is transmitted in the n-bit information. The CW is mapped to a TII signal through the signal mapper 410 and is modulated to an OFDM symbol through the OFDM modulator 407. The OFDM symbol is transmitted through a wireless network. For example, the above-described structure can be optionally provided with the repeater 401 for repeating the n-bit information in a P period.

Next, the orthogonal-set mapping process proposed in an exemplary embodiment of the present invention will be described in more detail.

That is, an exemplary embodiment of the present invention selects an orthogonal pattern from Table 1 to address a problem in which significant performance degradation occurs when a pattern for identifying a main ID of a TII signal is detected. For example, an orthogonal set is formed when p=0 and p=69 in Table 1. From Table 1, it can be seen that a TII transmission pattern is “00001111” when p=0, a TII transmission pattern is “11110000” when p=69, and the TII transmission patterns are orthogonal to each other. A sub ID has a range of from 0 to 23 and may independently form an orthogonal set. Because it is known that the sub ID has orthogonal characteristics, a detailed description is omitted. When orthogonal signal modulation is performed using one TII symbol, the number of orthogonal sets capable of being selected is a maximum of 48 (=2×24) because the number of main IDs is 2 and the number of sub IDs is 24.

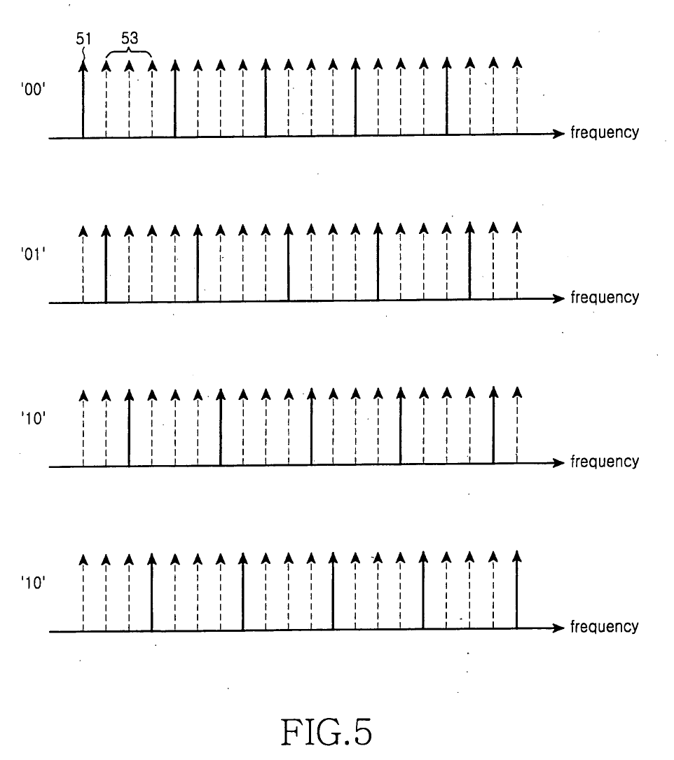

FIG. 5 illustrates an example of orthogonal signal mapping when 2 bits are transmitted in accordance with an exemplary embodiment of the present invention. In FIG. 5, it can be seen that orthogonal modulation is possible using different subcarriers. In FIG. 5, a solid line arrow 51 indicates a subcarrier through which ”1” is transmitted, and a dashed line arrow 53 indicates a subcarrier through which “0” is transmitted.

When an M-ary orthogonal signal set is defined as described above, signal point mapping is required to send transmitter-by-transmitter data. As described above, the present invention can use 48 orthogonal signal sets, but uses signal point mapping limited to a multiple of 2. In this case, a TII transmission rule of the present invention limits a maximum amount of information capable of being transmitted using one TII signal to 5 bits. Input bit information can be converted to an orthogonal symbol by performing 32-ary orthogonal signal point mapping. For example, it can be defined that a sub ID (4 bits) is used in a c range of from 1 to 16 and a main ID (1 bit) is used only in p=20 or 49.

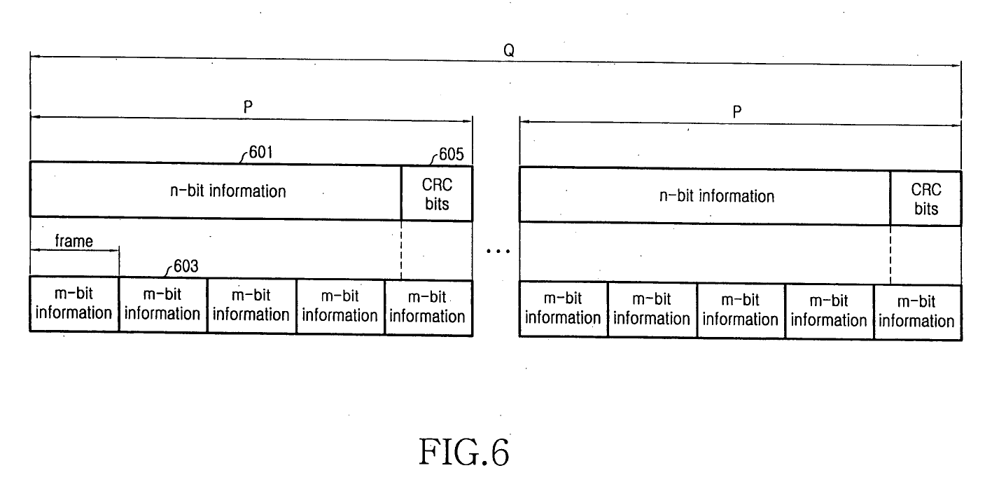

FIG. 6 illustrates a structure of a frame in accordance with an exemplary embodiment of the present invention.

As illustrated in FIG. 6, n-bit information 601 to be transmitted in a process for applying orthogonal signal modulation is divided into frames in an m-bit unit 603, each of m-bit frames is mapped to one TII signal according to the orthogonal signal mapping process, and a mapping result is transmitted in accordance with an exemplary embodiment of the present invention. However, degradation may occur due to multipath fading characteristics in a mobile channel environment even when n bits are transmitted using orthogonal signal sets. An exemplary embodiment of the present invention uses repetition transmission to exhibit multipath fading channel-robust characteristics. It is defined that an n-bit symbol (or sequence) is repeatedly transmitted in a P period. That is, n bits are repeatedly transmitted within a length range of Q as shown in FIG. 6 such that a relation of Q=P×N is satisfied. Herein, a repetition factor N may be set to an integer and can be set to a real number.

When n is not an integer multiple of m in a process for dividing the n-bit information into m-bit frames to map the n-bit information to the orthogonal signal set, the information is padded and transmitted. Padding bits can conventionally use “0” or “1”. However, Cyclic Redundancy Check (CRC) bits 605 can be transmitted using CRC to improve reception quality. If n is a multiple of m, the fading bits cannot be used and CRC bits can be additionally transmitted.

The period P and the repetition factor N can be transmitted to all receivers through a control channel such as an FIC channel of FIG. 1. When the period P and the repetition factor N are fixed (or stored) in advance in a receiver, overhead due to signaling can be reduced. The receiver can obtain time diversity according to symbol (sequence) repetition characteristics, such that TII reception quality can be improved also in a fading channel.

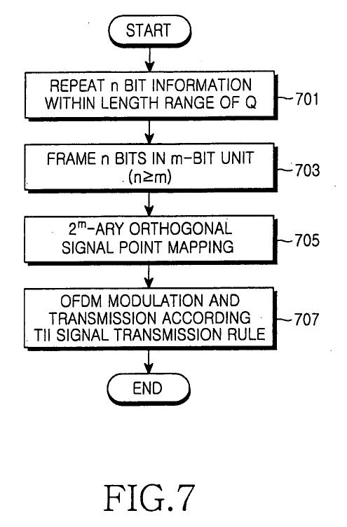

FIG. 7 is a flowchart illustrating a method for transmitting data in the digital broadcasting system in accordance with an exemplary embodiment of the present invention.

In step 701, the repeater 401 repeats input n-bit information in a P period within a length range of Q. Step 701 can be optionally performed. The n-bit information indicates a CW used as a common key value for descrambling broadcasting data in the broadcasting network when a conditional access system is applied to distinguish the broadcasting network and the relay network. In step 703, the frame divider 410 frames the n-bit information in a predefined bit (or m-bit) unit in every P period. Herein, m is set to be less than or equal to n. In step 705, the orthogonal signal point mapper 405 performs 2^{m}-ary orthogonal signal point mapping for an orthogonal set to transmit a TII. In. step 707, the OFDM modulator 407 modulates a mapped signal and then outputs the modulated mapped signal. A maximum amount of information is preferably 5 bits in the 2^{m}-ary orthogonal signal point mapping, and 32-ary orthogonal signal point mapping can be performed. However, the orthogonal signal point mapping does not need to be performed in a unit of 2^{m}.

When the data transmission method is used, common-key information of the broadcasting network for providing a free service is transmitted using a TII. Special authentication means are provided to distinguish services of the broadcasting network and the relay network without transmitting a TII to the relay network for providing a pay service. The orthogonal signal point mapping is performed to form an orthogonal set between a main ID and a sub ID of the TII and therefore reception quality of the TII is improved.

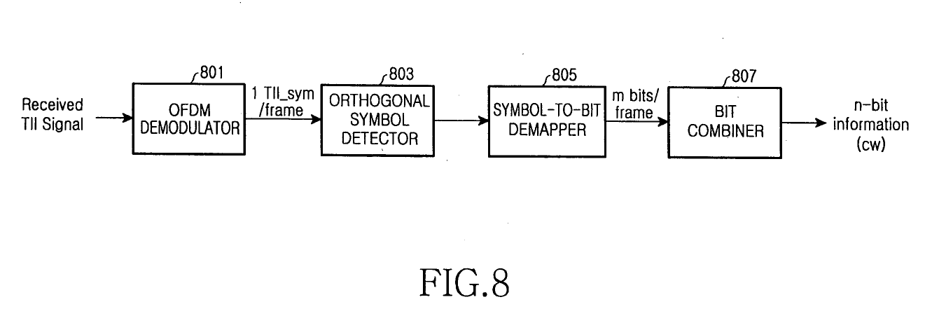

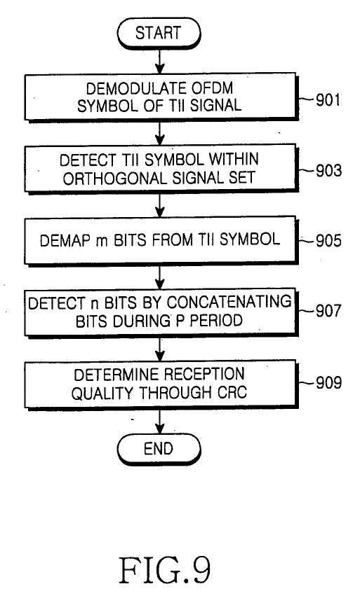

FIG. 8 is a block diagram illustrating a structure of a receiver in the digital broadcasting system in accordance with an exemplary embodiment of the present invention. The exemplary receiver will be described with reference to the data reception method of FIG. 9.

An OFDM demodulator 801 of the receiver of FIG. 8 demodulates an OFDM symbol from a NULL symbol position of a received frame in step 901. In step 903, an orthogonal symbol detector 803 detects a TII symbol within a predefined orthogonal signal set from the demodulated OFDM symbol. In step 905, a symbol-to-bit demapper 805 demaps a signal detected from each TII symbol to m bits. In step 907, a bit combiner 807 concatenates bits in a P period, generates n bits, and completes a reception process. If CRC bits are included in a received signal, a CRC function is performed in step 909. An error detection function may be additionally used. The receiver performs a time diversity combination on repeatedly transmitted information, thereby improving reception quality according to a channel status. For this diversity combination, the CRC bits and a CRC result can be used.

In the above-described exemplary embodiment, there has been described an example in which a TII signal to be transmitted in the terrestrial DMB system is used as a CW for distinguishing the broadcasting network and the relay network. That is, an associated transmitter of the broadcasting network is different from that of the relay network in that the associated transmitter of the broadcasting network can implement a conditional access system for transmitting a control signal for selective network access using the method of the present invention. The CW corresponding to the control signal is a common key value used for descrambling at the time of data demodulation. A transmitter can send a part or total of the CW according to an encryption level. A receiver detects the TII signal, thereby stably receiving the CW for data demodulation.

As is apparent from the above description, the present invention can stably receive a conditional access signal for distinguishing a broadcasting network and a relay network while maintaining compatibility with an existing network in digital broadcasting system using a single frequency network.

Moreover, the present invention can stably improve detection performance using only an orthogonal signal set when a TII is transmitted in the digital broadcasting system.

Moreover, the present invention can obtain superior detection performance in multipath fading because a time diversity combination is possible in a receiver when a TII is transmitted in the digital broadcasting system.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for transmitting information using a transmitter identification indicator (TII) in a digital broadcasting system, comprising the steps of:
framing input bit information in a predetermined bit unit;
mapping the framed input bit information to the TII using a predefined orthogonal set; and
modulating the TII to an Orthogonal Frequency Division Multiplexing (OFDM) symbol and transmitting the OFDM symbol.

2. The method of claim 1, further comprising the step of:
repeating the input bit information in a predetermined period before the framing step.

3. The method of claim 1, wherein the input bit information is common key information for descrambling broadcasting data when demodulation is performed in a receiver.

4. The method of claim 3, wherein when a network for providing a free broadcasting service is a broadcasting network and a network for providing a pay broadcasting service is a relay network, the common key is transmitted only to the broadcasting network.

5. The method of claim 1, wherein 2^{m}-ary orthogonal signal point mapping is performed in the step of mapping the framed input bit information to the TII.

6. The method of claim 5, wherein when m is 5, the orthogonal set for the TII is selected within a range of 32 orthogonal sets obtained by selecting 2 main identifiers (IDs) and 16 sub IDs.

7. The method of claim 1, wherein the orthogonal set is selected within a range of 48 orthogonal sets obtained by selecting 2 main identifiers (IDs) and 24 sub IDs.

8. A transmission apparatus for transmitting information using a transmitter identification indicator (TII) in a digital broadcasting system, comprising:
a frame divider for framing input bit information in a predetermined bit unit;
an orthogonal signal point mapper for mapping the framed input bit information to the TII using a predefined orthogonal set; and
a modulator for modulating the TII to an Orthogonal Frequency Division Multiplexing (OFDM) symbol and transmitting the OFDM symbol.

9. The transmission apparatus of claim 8, further comprising:
a repeater for repeating the input bit information in a predetermined period and inputting the repeated input bit information to the frame divider.

10. The transmission apparatus of claim 8, wherein the input bit information is common key information for descrambling data when demodulation is performed in a receiver.

11. The transmission apparatus of claim 10, wherein when a network for providing a free broadcasting service is a broadcasting network and a network for providing a pay broadcasting service is a relay network, transmission apparatus transmits the common key only to the broadcasting network.

12. The transmission apparatus of claim 8, wherein the orthogonal signal point mapper performs 2^{m}-ary orthogonal signal point mapping.

13. The transmission apparatus of claim 11, wherein when m is 5, the orthogonal set for the TII is selected within a range of 32 orthogonal sets obtained by selecting 2 main identifiers (IDs) and 16 sub IDs.

14. The method of claim 8, wherein the orthogonal set is selected within a range of 48 orthogonal sets obtained by selecting 2 main identifiers (IDs) and 24 sub IDs.

15. A reception method for use in a digital broadcasting system for transmitting a Transmitter Identification Indicator (TII), comprising the steps of:
detecting a TII symbol from a predefined orthogonal signal set after demodulating an Orthogonal Frequency Division Multiplexing (OFDM) symbol;
demapping predetermined bits from the TII symbol; and
concatenating the demapped bits in a predetermined period unit and outputting bit information.

16. The reception method of claim 15, further comprising the step of:
demodulating received broadcasting data using the bit information when the bit information is common key information for descrambling data.

17. The reception method of claim 16, wherein when a network for providing a free broadcasting service is a broadcasting network and a network for providing a pay broadcasting service is a relay network, the TII is transmitted only in the broadcasting network.

18. A reception apparatus for use in a digital broadcasting system for transmitting a Transmitter Identification Indicator (TII), comprising:
an Orthogonal Frequency Division Multiplexing (OFDM) demodulator for demodulating a received OFDM symbol;
an orthogonal symbol detector for detecting a TII symbol from a predefined orthogonal signal set within the demodulated OFDM symbol;
a symbol-to-bit demapper for demapping predetermined bits from the TII symbol; and
a bit combiner for concatenating the demapped bits in a predetermined period unit and outputting bit information.

19. The reception apparatus of claim 18, further comprising:
descrambling means for demodulating received broadcasting data using the bit information when the bit information is common key information for descrambling the data.

20. The reception apparatus of claim 19, wherein when a network for providing a free broadcasting service is a broadcasting network and a network for providing a pay broadcasting service is a relay network, the TII is transmitted only in the: broadcasting network.

21. A digital broadcasting system for transmitting information using a transmitter identification indicator (TII), comprising:
a transmitter for framing input bit information in a predetermined bit unit, mapping the framed input bit information to the TII using a predefined orthogonal set, modulating the TII to an Orthogonal Frequency Division Multiplexing (OFDM) symbol, and transmitting the OFDM symbol; and
a receiver for demodulating a received OFDM symbol, detecting a TII symbol from a predefined orthogonal signal set within the demodulated OFDM symbol, demapping predetermined bits from the TII symbol, concatenating the demapped bits in a predetermined period unit, and outputting bit information.

22. The digital broadcasting system of claim 21, wherein when a network for providing a pay broadcasting service is a broadcasting network and a network for providing a free broadcasting service is a relay network, the receiver descrambles received broadcasting data using the bit information included in the TII, the TII being transmitted only in the broadcasting network.

23. The digital broadcasting system of claim 21, wherein the orthogonal set is selected within a range of 48 orthogonal sets obtained by selecting 2 main identifiers (IDs) and 24 sub IDs.
